(19) United States
(12) Patent Application Publication
(10) Pub. No.: US 2026/0009481 A1
(43) Pub. Date: Jan. 8, 2026

(54) UNION BOLT FOR REDUCING FLUID PRESSURE NOISE

(71) Applicant: LS MTRON LTD., Anyang-si (KR)

(72) Inventors: Junguk LEE, Anyang-si (KR); Jai Yoon SHIN, Anyang-si (KR); Seung Ho CHEONG, Anyang-si (KR)

(21) Appl. No.: 19/328,680

(22) Filed: Sep. 15, 2025

Related U.S. Application Data
(63) Continuation of application No. PCT/KR2024/002446, filed on Feb. 26, 2024.

(30) Foreign Application Priority Data
Mar. 21, 2023 (KR) 10-2023-0036622

(51) Int. Cl. F16L 15/08; F16L 15/00; F16L 55/027

(52) U.S. Cl. CPC F16L 15/08; F16L 15/006; F16L 55/02754

(57) ABSTRACT

The present disclosure is directed to a union bolt for reducing fluid pressure noise. The union bolt according to the present disclosure has a mounting chamber capable of accommodating a silencer therein, and the silencer is mounted in the mounting chamber. According to the present disclosure, the union bolt contains the silencer therein, so that the noise caused by fluid pressure can be reduced and the assembly efficiency of a fluid pressure line can be improved.

### CROSS-REFERENCE TO RELATED APPLICATION

This application is a Continuation application of International Application No. PCT/KR2024/002446, filed Feb. 26, 2024, which claims priority to and the benefit of Korean Patent Application No. 10-2023-0036622, filed Mar. 21, 2023, the disclosures of which are incorporated herein by reference in its entirety.

### FIELD

The present disclosure relates to a union bolt for connecting flow paths, and more particularly, to technology for reducing noise generated during the transmission of fluid pressure.

### BACKGROUND

A union bolt is a connection component for connecting between flow paths that are present in different objects.

Automobiles, special machines, and the like have actuators that are operated by the pressure of fluid such as air or oil (hereinafter referred to as “fluid pressure”).

Fluid pressure is transmitted from a fluid pressure pump to an actuator through a connection flow path.

Although the connection flow path may be composed of a single conduit, it is frequently implemented as a plurality of flow paths due to a spatial structure or relationships with other structures or the like.

Separate flow paths are frequently connected to each other by using union bolts.

Union bolts are preferred connection components because they allow for the connection between flow paths only through simple fastening.

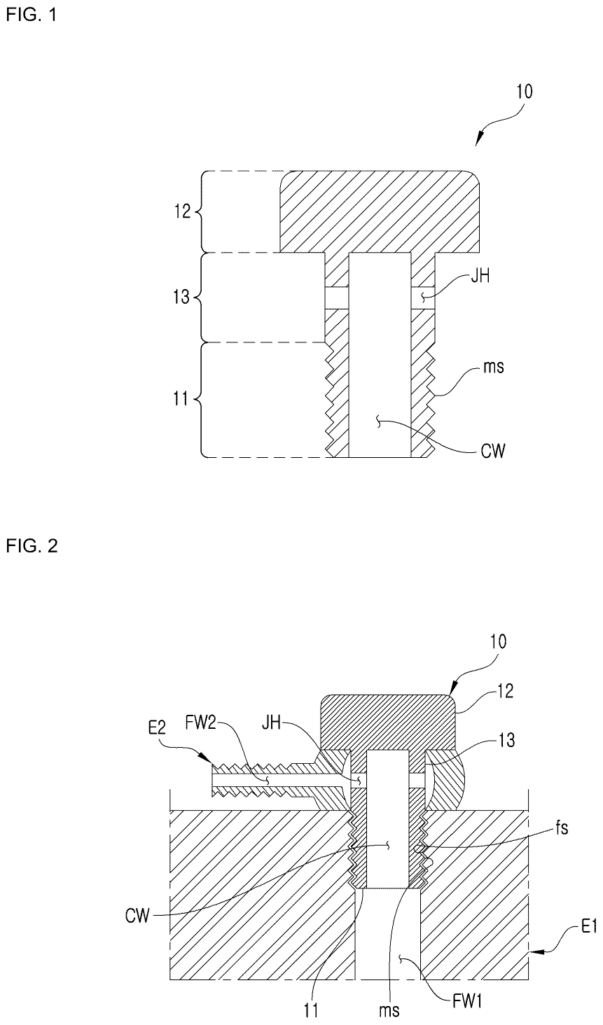

FIG. 1 is a sectional view of a typical union bolt 10, and FIG. 2 is a sectional view of a state in which the union bolt 10 of FIG. 1 is applied.

The union bolt 10 may be divided into a fastening portion 11, a head portion 12, and a connection portion 13.

The fastening portion 11 is a portion that is fastened to a first object E1 having a first flow path FW1 by screw coupling. A male thread ms is formed on the outer surface of the fastening portion 11. It is obvious that a female thread fs for engagement with the male thread ms is formed on the first object E1.

The head portion 12 is a portion for receiving rotational force for fastening from a work tool (e.g., an electric tool for bolt fastening, a spanner, or the like) so that fastening is performed by the fastening portion 11.

The head portion 12 has a shape for engagement with the work tool, and typically has a hexagonal shape.

The connection portion 13 is positioned between the fastening portion 11 and the head portion 12.

A connection hole JH that is connected with a second flow path FW2 in a second object E2 is formed in the connection portion 13.

The union bolt 10 has a hollow flow path CW that extends from an end of the fastening portion 11 to the connection portion 13.

The front end of the hollow flow path CW communicates with the connection hole JH, and the rear end thereof communicates with the first flow path FW1. Accordingly, the hollow flow path CW and the connection hole JH connect the first and second flow paths FW1 and FW2 to each other.

However, the direction of fluid pressure changes abruptly at the point where the union bolt 10 is present, so that pulsating noise is inevitable at the corresponding point.

Pulsating noise may be reduced by mounting a silencer.

The silencer may be implemented as a cavity-type silencer having a conduit expansion structure. However, there are many cases having a structure (a compact structure) in which various components are tightly packed, so that it may be impossible to implement a cavity-type silencer through conduit expansion.

Accordingly, a structure in which a separate mounting location is secured through the branching of a conduit and a silencer is mounted in the secured space may be taken into consideration. However, depending on the equipment, it may not be easy to secure a separate mounting space for the mounting of a silencer.

Alternatively, a structure in which a separate port is formed at the top end of the union bolt 10 may be adopted, and a silencer may be mounted therein. However, in the case of this example, the workability for the fastening of the union bolt 10 is poor. For example, there may be the inconvenience of having to manually fasten the union bolt 10 because a power tool may not engage with the head portion 12 of the union bolt 10.

### PRIOR ART LITERATURE

### Patent Literature

(Patent Document 1) Korean Patent Application Publication No. 10-2018-0130245

### SUMMARY

The present disclosure has been conceived from the contemplation of a union bolt capable of reducing noise attributable to fluid pressure.

According to a first aspect of the present disclosure, there is provided a union bolt for reducing fluid pressure noise, the union bolt including: a fastening portion configured such that a male thread is formed on the outer surface thereof to be fastened to a first object having a first flow path through which fluid passes; a head portion configured to receive rotational force from a working tool so that fastening by the fastening portion is achieved; and a connection portion positioned between the fastening portion and the head portion, and provided with a connection hole connected to a second flow path of a second object having the second flow path through which fluid passes; and wherein the union bolt has a hollow flow path that is formed in a hollow shape extending from an end of the fastening portion to the connection portion and serves as a flow path connecting between the connection hole and the first flow path; and wherein the union bolt has a mounting chamber that is formed to expand from the hollow flow path toward the head portion and is shaped to accommodate a silencer for reducing noise.

A female thread for coupling with the silencer may be formed on an inner circumferential surface forming the mounting chamber.

The mounting chamber may be closed except for a direction facing the hollow flow path.

At least a portion of the mounting chamber may be formed in the head portion.

The union bolt may further include a silencer configured to be mounted in the mounting chamber and reduce noise.

The silencer may include: a body portion provided with a resonance space for noise reduction; and a neck portion configured to extend from the body portion and have a communication path allowing the resonance space to communicate with the hollow flow path.

A distal end of the neck portion may protrude into a region where the connection hole is present.

The neck portion may have an engagement structure that can engage with a mounting tool for mounting the silencer in the mounting chamber by rotating the silencer.

According to a second aspect of the present disclosure, there is provided a union bolt for reducing fluid pressure noise, the union bolt including: a fastening portion configured such that a male thread is formed on an outer surface thereof to be fastened to a first object having a first flow path through which fluid passes; a head portion configured to receive rotational force from a working tool so that fastening by the fastening portion is achieved; and a connection portion positioned between the fastening portion and the head portion, and provided with a connection hole connected to a second flow path of a second object having the second flow path through which fluid passes; and wherein the union bolt has a hollow flow path that is formed in a hollow shape extending from an end of the fastening portion to the connection portion and serves as a flow path connecting between the connection hole and the first flow path; and wherein the union bolt has a resonance chamber that is formed in a direction from the hollow flow path toward the head portion to reduce noise.

The union bolt may further include a partition wall configured to separate the hollow flow path and the resonance chamber from each other, and at least one communication path configured to allow the resonance chamber to communicate with the hollow flow path may be formed in the partition wall.

According to the present disclosure, the union bolt itself contains the Helmholtz silencer therein, so that it provides the effects of providing improved assemblability and space utilization while reducing noise.

### BRIEF DESCRIPTION OF THE DRA WINGS

FIGS. 1 and 2 are reference views illustrating a general union bolt;

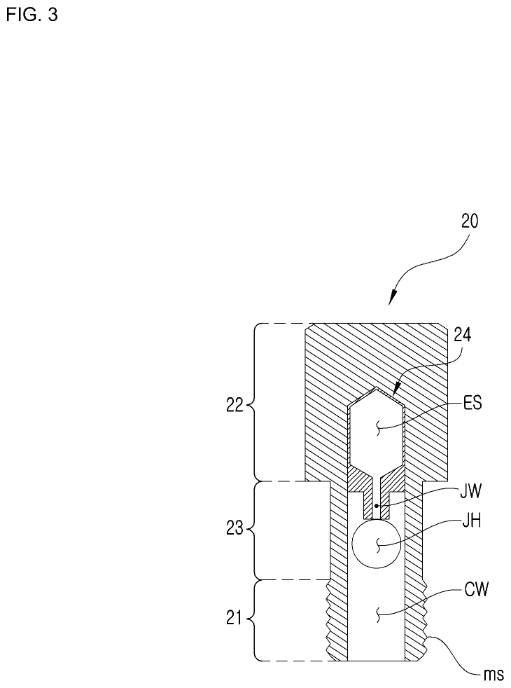

FIGS. 3 to 8 are reference views illustrating a union bolt for reducing fluid pressure noise according to a first embodiment of the present disclosure;

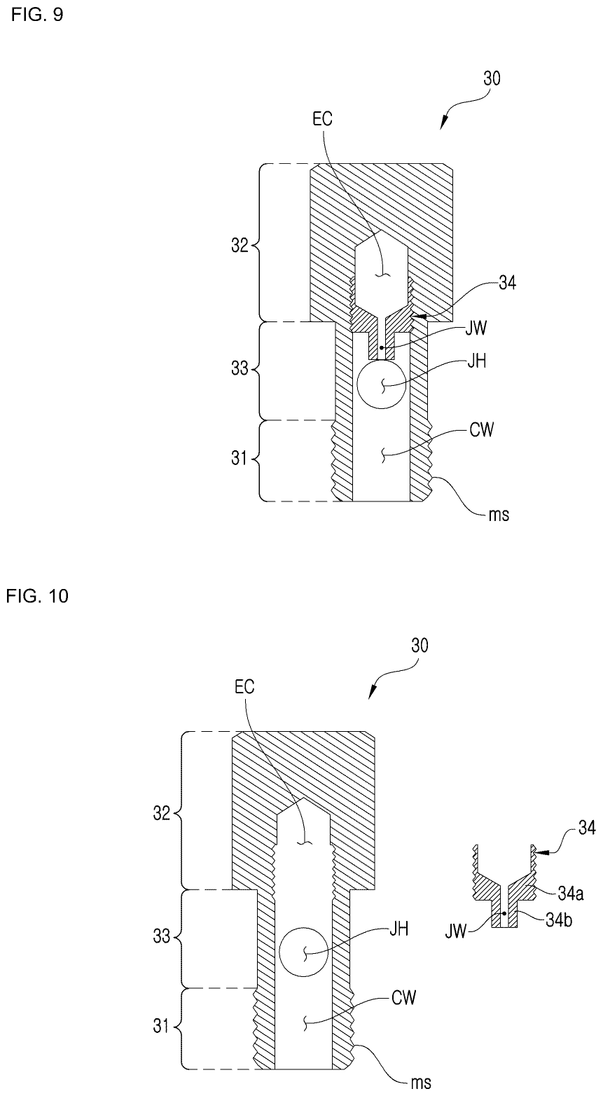

FIGS. 9 and 10 are reference views illustrating a union bolt for reducing fluid pressure noise according to a second embodiment of the present disclosure;

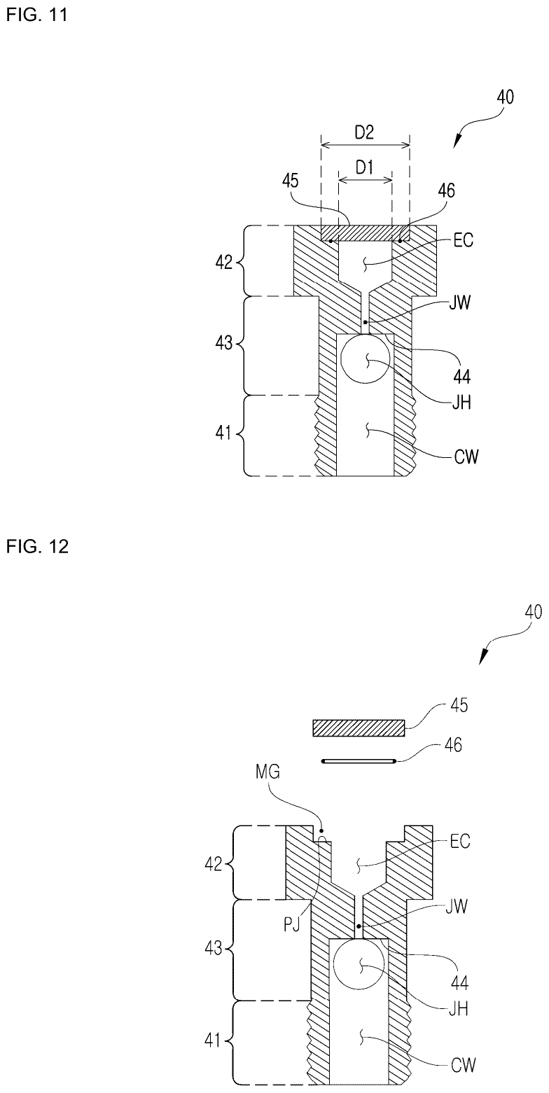

FIGS. 11 and 12 are reference views illustrating a union bolt for reducing fluid pressure noise according to a third embodiment of the present disclosure;

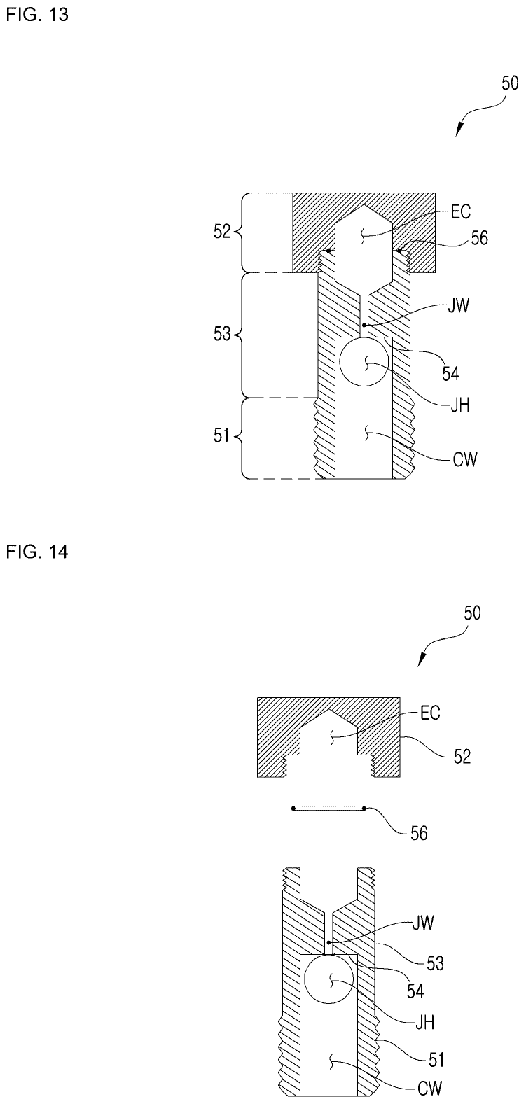

FIGS. 13 and 14 are reference views illustrating a union bolt for reducing fluid pressure noise according to a third embodiment of the present disclosure; and

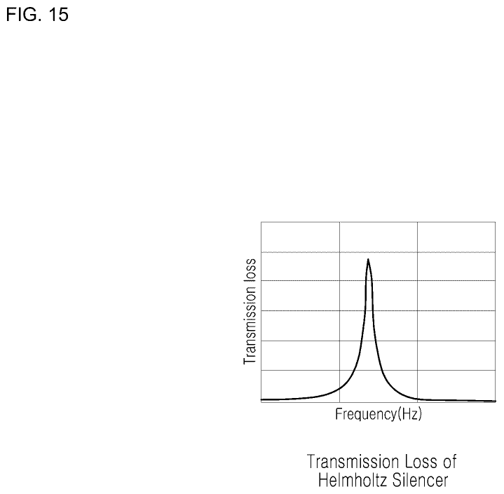

FIG. 15 is an auxiliary diagram illustrating a reference note.

### DETAILED DESCRIPTION

Preferred embodiments of the present disclosure will be described with reference to the accompanying drawings. For brevity of description, descriptions of well-known or repetitive components will be omitted or abridged as much as possible.

### First Embodiment

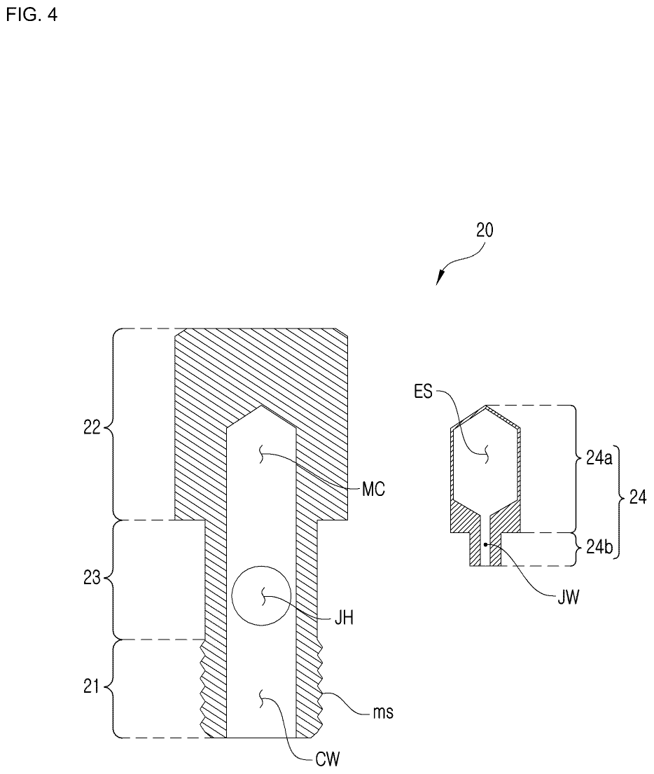

FIG. 3 is a schematic sectional view of a union bolt 20 for reducing fluid pressure noise (hereinafter referred to as the “union bolt”) according to a first embodiment of the present disclosure, and FIG. 4 is an exploded view of the union bolt 20 of FIG. 3.

The union bolt 20 according to the present embodiment may be divided into a fastening portion 21, a head portion 22, and a connection portion 23.

The fastening portion 21 is a portion that is fastened to a first object E1, and a male thread ms is formed on the outer surface of the fastening portion 21.

The first object E1 has a first flow path FW1 through which fluid flows.

The head portion 22 is a portion for receiving rotational force from a work tool to achieve fastening by the fastening portion 21.

The head portion 22 has a polygonal shape around the edge thereof, enabling the application of rotational force with a work tool.

The connection portion 23 is positioned between the fastening portion 21 and the head portion 22.

The connection portion 23 is a portion that is connected to a second object E2, and a connection hole JH is formed through the connection portion 23.

The second object E2 has a second flow path FW2 through which fluid flows.

The second flow path FW2 is connected with the connection hole JH.

Furthermore, the union bolt 20 has a hollow flow path CW that extends from an end of the fastening portion 21 to the connection portion 23.

The hollow flow path CW serves as a flow path that connects between the connection hole JH and the first flow path FW1.

The front end of the hollow flow path CW communicates with the connection hole JH, and the rear end thereof communicates with the first flow path FW1. Accordingly, the hollow flow path CW and the connection hole JH connect the first flow path FW1 and the second flow path FW2. That is, the first and second flow paths FW1 and FW2 communicate with each other through the hollow flow path CW and the connection hole JH.

As clearly shown in FIG. 4, the union bolt 20 according to the present embodiment has a mounting chamber MC that is formed to expand from the hollow flow path CW toward the head portion 22.

The mounting chamber MC is shaped to allow a silencer 24 for noise reduction to be mounted therein.

The mounting chamber MC is closed except for a direction facing the hollow flow path CW.

At least a portion of the mounting chamber MC is formed in the head portion 22, thereby minimizing an increase in the overall length of the union bolt 20.

Furthermore, the union bolt 20 according to the present embodiment further includes the silencer 24 mounted in the mounting chamber MC.

The silencer 24 has a body portion 24a and a neck portion 24b.

The body portion 24a has a resonance space ES for noise reduction, and is generally disposed in the head portion 22.

The neck portion 24b is formed to extend from the body portion 24a toward the hollow flow path CW.

The neck portion 24b has a communication path JW for allowing the resonance space ES to communicate with the hollow flow path CW.

According to the present embodiment, the noise generated by the fluid passing through the first and second flow paths FW1 and FW2 is reduced through a resonance phenomenon that occurs in the resonance space ES of the silencer 24.

The union bolt 20 of the present embodiment has the silencer 24 mounted in the inner mounting chamber MC, so that the outer surface of the head portion 22 can engage with a power-driven tool. Accordingly, the union bolt 20 may be easily fastened to the first object E1 by using the power-driven tool.

Meanwhile, various methods for mounting the silencer 24 in the mounting chamber MC may be taken into consideration, and these methods will be described below:

### 1. Forced Fit Method

An implementation may be made such that the silencer 24 can be mounted in the mounting chamber MC by using a forced fit method.

In this case, the silencer 24 is mounted in the mounting chamber MC by inserting the silencer 24 into the mounting chamber MC through the hollow flow path CW and then forcibly pressing it toward the mounting chamber MC.

### 2. Welding Method

A structure may be adopted in which the silencer 24 is inserted through the hollow flow path CW, is positioned in the mounting chamber MC, and is then mounted via spot welding or the like.

### 3. Screw Fastening Method

A structure may be adopted in which the silencer 24 is inserted through the hollow flow path CW and is then rotated to be mounted via a screw fastening method.

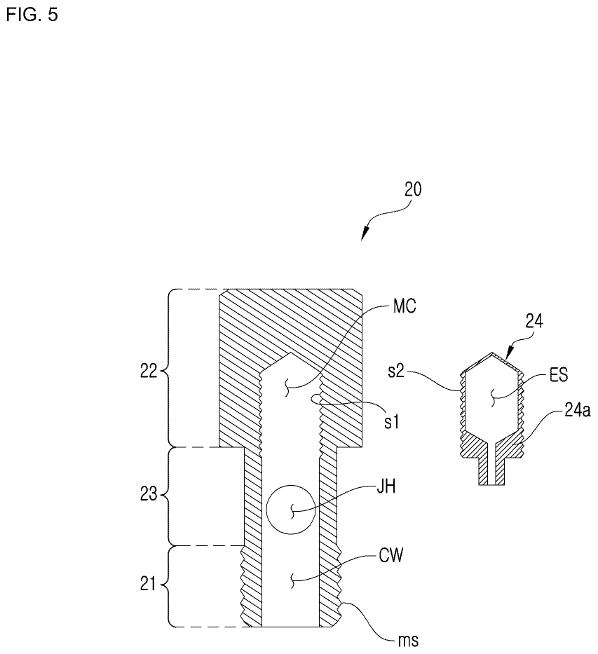

When a screw fastening method is adopted, a female thread s1 configured to be coupled with the silencer 24 is formed on the inner circumferential surface of the mounting chamber MC, as shown in FIG. 5.

In addition, to enable screw coupling with the female thread s1 of the mounting chamber MC, the silencer 24 is provided with a male thread s2 on the outer circumferential surface of the body portion 24a.

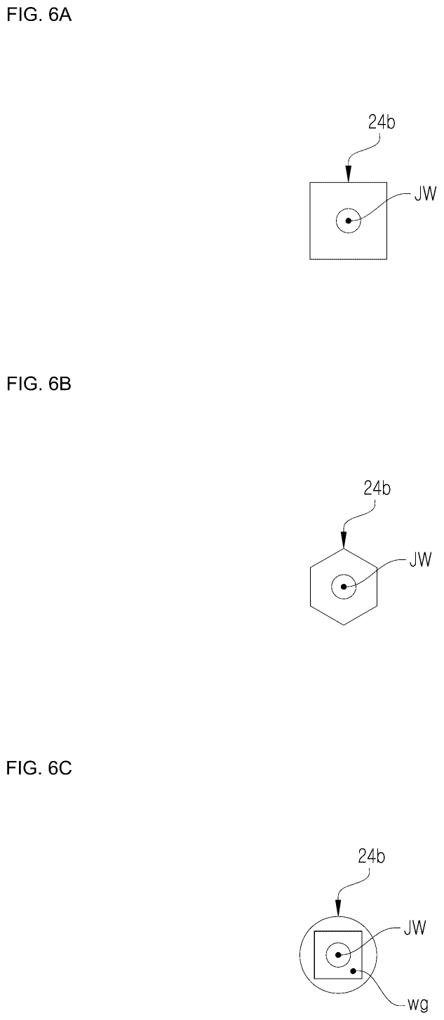

Furthermore, as shown in FIGS. 6A and 6B, the periphery of the neck portion 24b may have a polygonal shape, such as a square or hexagonal shape, to facilitate the easy manipulation of the rotation of the silencer 24. Alternatively, as shown in FIG. 6C, a wrench depression WG may be formed on the neck portion 24b. That is, to mount the silencer 24 in the mounting chamber MC by rotating the silencer 24, the neck portion 24b has an engagement structure that can engage with a mounting tool.

By adopting a screw fastening method, the location of the silencer 24 may be precisely set, and there is no need to extend an assembly portion (a screw fastening portion), which is advantageous for securing the mounting space MC.

Next, another implementation example of the first embodiment will be described.

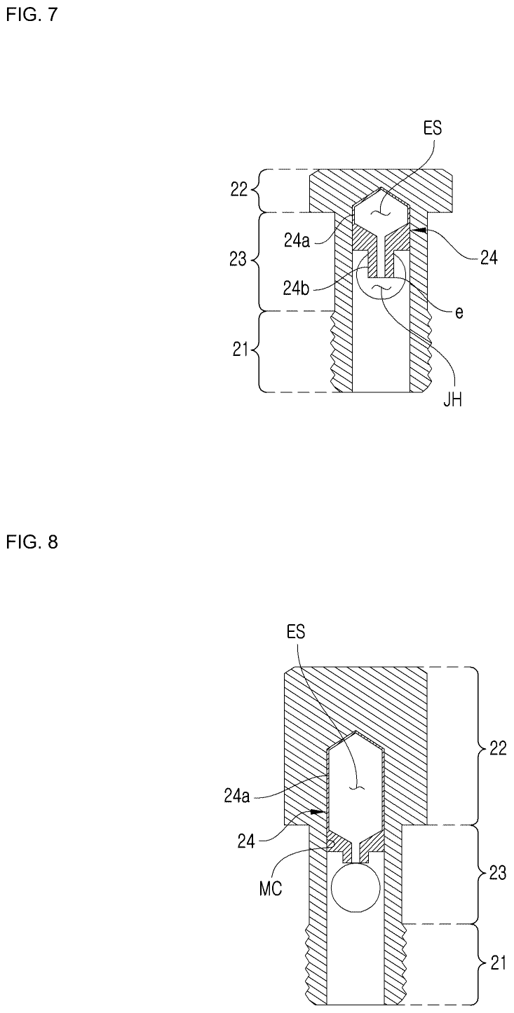

For example, as shown in FIG. 7, a body portion 24a of a silencer 24 may be implemented to be formed as close as possible to a connection hole JH. Accordingly, a distal end e of a neck portion 24b protrudes into a region where the connection hole JH is present. The body portion 24a is mounted across a head portion 22 and a connection portion 23. Furthermore, a resonance space ES is also formed across the head portion 22 and the connection portion 23.

According to the implementation example of FIG. 7, the length of the head portion 22 may be minimized, which is advantageous for space utilization.

For example, as shown in FIG. 8, an implementation may be made such that the head portion 22 is formed to be longer and the mounting chamber MC is formed to be longer.

According to the example of FIG. 8, the body portion 24a of the silencer 24 may be formed to be longer to maximize the volume of the resonance space ES, thereby improving noise reduction efficiency.

The examples of FIGS. 3, 7, and 8 above may be selectively employed depending on the amount of space available at the location at which the union bolt 20 will be disposed.

### Second Embodiment

FIG. 9 is a schematic sectional view of a union bolt 30 according to a second embodiment of the present disclosure, and FIG. 10 is an exploded view of the union bolt 30 of FIG. 9.

The union bolt 30 according to the present embodiment may be divided into a fastening portion 31, a head portion 32, and a connection portion 33.

The fastening portion 31 is a portion that is fastened to the first object E1 having the first flow path FW1.

The head portion 32 is a portion for receiving rotational force from a work tool to the union bolt 30 to fasten the union bolt 30 and the first object E1 to each other.

The connection portion 33 is a portion that is positioned between the fastening portion 31 and the head portion 32 and is connected to the second object E2 having the second flow path FW2. A connection hole JH for connection with the second flow path FW2 is formed in the connection portion 33.

In the same manner, the union bolt 30 has a hollow-shaped hollow flow path CW that extends from an end of the fastening portion 31 to the connection portion 33.

The first and second flow paths FW1 and FW2 communicate with each other through the hollow flow path CW and the connection hole JH.

The union bolt 30 according to the present embodiment has a resonance chamber EC that is formed to expand from the hollow flow path CW toward the head portion 32.

The resonance chamber EC is closed except for a direction facing the hollow flow path CW.

At least a portion of the resonance chamber EC is formed in the head portion 32, thereby minimizing an increase in the overall length of the union bolt 30.

Furthermore, the union bolt 30 according to the present embodiment further includes a partition wall 34 that separates the resonance chamber EC and the hollow flow path CW from each other.

The partition wall 34 is mounted between the resonance chamber EC and the hollow flow path CW.

The partition wall 34 has a mounting portion 34a and a neck portion 34b.

The mounting portion 34a may be mounted on the inner circumferential surface between the resonance chamber EC and the hollow flow path CW by forced fitting, screw fastening, or welding.

The neck portion 34b extends from the mounting portion 34a toward the hollow flow path CW.

The neck portion 34b has a communication path JW for allowing the resonance chamber EC to communicate with the hollow flow path CW.

According to the present embodiment, the noise generated by the fluid passing through the first and second flow paths FW1 and FW2 is reduced through a resonance phenomenon that occurs in the resonance chamber EC.

The union bolt 30 of the present embodiment has the advantage of high manufacturing efficiency because the partition wall 34 that is easier to manufacture than the silencer 24 of the first embodiment is applied to the union bolt 30.

In the same manner, even when the present embodiment is employed, the volume of the resonance chamber EC and the location of the neck portion 34b may be implemented in various manners.

### Third Embodiment

FIG. 11 is a schematic sectional view of a union bolt 40 according to a third embodiment of the present disclosure, and FIG. 12 is an exploded view of the union bolt 40 of FIG. 11.

The union bolt 40 according to the present embodiment may be divided into a fastening portion 41, a head portion 42, a connection portion 43, and a partition wall 44.

The fastening portion 41 is a portion that is fastened to the first object E1 having the first flow path FW1.

The head portion 42 is a portion for receiving rotational force from a work tool to the union bolt 40 to fasten the union bolt 40 and the first object E1 to each other.

According to the present embodiment, the head portion 42 has a mounting depression MG for accommodating a lid 45 to be described later.

The connection portion 43 is a portion that is positioned between the fastening portion 41 and the head portion 42 and is connected to the second object E2 having the second flow path FW2. A connection hole JH for connection with the second flow path FW2 is formed in the connection portion 43.

In the same manner, the union bolt 40 has a hollow-shaped hollow flow path CW that extends from an end of the fastening portion 41 to the connection portion 43.

The first and second flow paths FW1 and FW2 communicate with each other through the hollow flow path CW and the connection hole JH.

According to the present embodiment, a resonance chamber EC is formed on the side opposite the hollow flow path CW with the partition wall 44 interposed therebetween. That is, the partition wall 44 separates the resonance chamber EC and the hollow flow path CW from each other.

The diameter D1 of the resonance chamber CW is smaller than the diameter D2 of the mounting depression MG.

A communication path JW for allowing the resonance chamber CW and the hollow flow path CW to communicate with each other is formed in the partition wall 44.

Although a single communication path JW having a large diameter may be formed, a plurality of communication paths JW having a small diameter may be formed. When the plurality of communication paths JW having a small diameter are formed, cancellation through the interference of pulsating pressures entering the resonance chamber EC via various paths may be achieved better depending on tuning, resulting in improved noise reduction efficiency.

In the union bolt 40 according to the present embodiment, the resonance chamber EC is open on the side opposite the hollow flow path CW. Accordingly, the union bolt 40 further includes the lid 45 for closing the resonance chamber EC.

The lid 45 is mounted in the mounting depression MG of the head portion 42.

The lid 45 may be implemented to be mounted in the head portion 42 by using any one of forced fitting, screw fastening, and welding.

For reference, the diameter D1 of the resonance chamber EC is smaller than the diameter D2 of the mounting depression MG, so that a stop protrusion PJ is formed between the resonance chamber EC and the mounting depression MG.

The stop protrusion PJ prevents the excessive entry of the lid 45 in a process in which the lid 45 is mounted in the head portion 42.

Furthermore, a sealing ring 46 may be further provided between the stop protrusion PJ and the lid 45. The sealing ring 46 prevents fluid from leaking between the outer circumferential surface of the lid 45 and the inner circumferential surface forming the mounting depression MG.

In the second embodiment, the partition wall 34 is manufactured and mounted separately, whereas in the third embodiment, the partition wall 44 is integrated with the head portion 42 and the connection portion 43.

According to the present embodiment, there is an advantage in that the manufacturability of the resonance chamber EC is desirable.

Even when the third embodiment is employed, the volume of the resonance chamber EC, the length of the communication path JW, and the individual locations may be implemented in various manners.

### Fourth Embodiment

FIG. 13 is a schematic sectional view of a union bolt 50 according to a fourth embodiment of the present disclosure, and FIG. 14 is an exploded view of the union bolt 50 of FIG. 13.

The union bolt 50 according to the present embodiment may be divided into a fastening portion 51, a head portion 52, a connection portion 53, and a partition wall 54.

The fastening portion 51 is a portion that is fastened to the first object E1 having the first flow path FW1.

The head portion 52 is a portion for receiving rotational force from a work tool to the union bolt 50 to fasten the union bolt 50 and the first object E1 to each other.

The connection portion 53 is a portion that is positioned between the fastening portion 51 and the head portion 52 and is connected to the second object E2 having the second flow path FW2. A connection hole JH for connection with the second flow path FW2 is formed in the connection portion 53.

The union bolt 50 has a hollow-shaped hollow flow path CW that extends from an end of the fastening portion 51 to the connection portion 53.

The first and second flow paths FW1 and FW2 communicate with each other through the hollow flow path CW and the connection hole JH.

According to the present embodiment, the head portion 52 is manufactured separately and coupled with the connection portion 53. That is, the head portion 52 is fabricated and manufactured separately, and the fastening portion 51 and the connection portion 53 are fabricated and manufactured in an integrated form.

A resonance chamber EC is formed in the head portion 52. A partition wall 54 that separates the resonance chamber EC and the hollow flow path CW from each other when the connection portion 53 is coupled with the head portion 52 is formed on the connection portion 53.

A communication path JW for allowing the resonance chamber EC and the hollow flow path CW to communicate with each other is formed in the partition wall 54.

At least one communication path JW may be formed.

Even in the present embodiment, a sealing ring 56 for preventing the leakage of fluid may be further provided between the head portion 52 and the connection portion 53.

When the present embodiment is employed, there are advantages in that the manufacturability of the resonance chamber EC is desirable and the loss of raw materials can be minimized.

For reference, when the fourth embodiment is employed, the resonance chamber EC may be formed only in the head portion 52, may be formed only in the connection portion 53, or may be formed across the head portion 52 and the connection portion 53.

### REFERENCE NOTE

The present disclosure intends to utilize the principle of a Helmholtz resonator.

As shown in the example in FIG. 15, a silencer utilizing the principle of a Helmholtz resonator exhibits a significant increase in transmission loss at a specific resonant frequency f.

The resonant frequency f is defined by the following Equation 1:

$$f = \frac{V}{2 π} \sqrt{\frac{A}{V L}} \qquad ( 1 )$$

As for the above equation, it can be seen that the resonant frequency f is related to A, V, and L.

In the present disclosure, A corresponds to the cross-sectional area of the connection hole JW, V corresponds to the volume of the resonance space ES, and L corresponds to the length of the neck portion 24b or 34b.

In other words, by adjusting the cross-sectional area A of the connection hole JW, the volume V of the resonance space ES, and the length L of the neck portion 24b or 34b, the union bolt 20, 30, 40, or 50 capable of eliminating noise in a required specific frequency band may be manufactured.

It is obvious that it may also be desirable to implement a fluid circuit/hydraulic circuit by using the union bolt 20, 30, 40, or 50 having specifications and a spatial arrangement optimized for the reduction of noise in a specific frequency band among the above various embodiments.

The above-described embodiments are merely illustrative of preferred examples of the present disclosure, and may have various forms of application. Therefore, the present disclosure should not be understood as being limited solely to the above-described content. Instead, the scope of the present disclosure should be understood as encompassing the scope of the separately described claims and their equivalents.

1. A union bolt for reducing fluid pressure noise, the union bolt comprising:
a fastening portion configured such that a male thread is formed on an outer surface thereof to be fastened to a first object having a first flow path through which fluid passes;
a head portion configured to receive rotational force from a working tool so that fastening by the fastening portion is achieved; and
a connection portion positioned between the fastening portion and the head portion, and provided with a connection hole connected to a second flow path of a second object having the second flow path through which fluid passes; and
wherein the union bolt has a hollow flow path that is formed in a hollow shape extending from an end of the fastening portion to the connection portion and serves as a flow path connecting between the connection hole and the first flow path; and
wherein the union bolt has a mounting chamber that is formed to expand from the hollow flow path toward the head portion and is shaped to accommodate a silencer for reducing noise.

2. The union bolt of claim 1, wherein a female thread for coupling with the silencer is formed on an inner circumferential surface forming the mounting chamber.

3. The union bolt of claim 1, wherein the mounting chamber is closed except for a direction facing the hollow flow path.

4. The union bolt of claim 1, wherein at least a portion of the mounting chamber is formed in the head portion.

5. The union bolt of claim 1, further comprising a silencer configured to be mounted in the mounting chamber and reduce noise.

6. The union bolt of claim 5, wherein the silencer comprises:
a body portion provided with a resonance space for noise reduction; and
a neck portion configured to extend from the body portion and have a communication path allowing the resonance space to communicate with the hollow flow path.

7. The union bolt of claim 6, wherein a distal end of the neck portion protrudes into a region where the connection hole is present.

8. The union bolt of claim 6, wherein the neck portion has an engagement structure that engages with a mounting tool for mounting the silencer in the mounting chamber by rotating the silencer.

9. A union bolt for reducing fluid pressure noise, the union bolt comprising:
a fastening portion configured such that a male thread is formed on an outer surface thereof to be fastened to a first object having a first flow path through which fluid passes;
a head portion configured to receive rotational force from a working tool so that fastening by the fastening portion is achieved; and
a connection portion positioned between the fastening portion and the head portion, and provided with a connection hole connected to a second flow path of a second object having the second flow path through which fluid passes; and
wherein the union bolt has a hollow flow path that is formed in a hollow shape extending from an end of the fastening portion to the connection portion and serves as a flow path connecting between the connection hole and the first flow path; and
wherein the union bolt has a resonance chamber that is formed in a direction from the hollow flow path toward the head portion to reduce noise.

10. The union bolt of claim 9, further comprising a partition wall configured to separate the hollow flow path and the resonance chamber from each other,
wherein at least one communication path configured to allow the resonance chamber to communicate with the hollow flow path is formed in the partition wall.
